(19) United States
(12) Patent Application Publication
(10) Pub. No.: US 2024/0046014 A1
(43) Pub. Date: Feb. 8, 2024

(54) PROCESS TO RELAY KNOWLEDGE AND GUIDE SYNTHESIS ALONGSIDE EARLY DETECTION OF LOGIC OPTIMIZATIONS

(71) Applicant: Synopsys, Inc., Mountain View, CA (US)

(72) Inventors: Himanshu KATHURIA, Fremont, CA (US); Rohit Kumar OHLAYAN, New Delhi (IN); Paras Mal JAIN, Mountain View, CA (US); Vrinda Achuthan PADMAKUMARI, Sunnyvale, CA (US); Harpreet Singh ANAND, Nagar (IN); Ila VERMA, Rajpura (IN); Priya NAYAK, Milpitas, CA (US); Suresh Babu BARLA, Fremont, CA (US); Judy SZE, Palo Alto, CA (US)

(21) Appl. No.: 18/071,396

(22) Filed: Nov. 29, 2022

Related U.S. Application Data
(60) Provisional application No. 63/396,113, filed on Aug. 8, 2022.

(51) Int. Cl. G06F 30/33; G06F 30/337

(52) U.S. Cl. CPC G06F 30/33; G06F 30/337; G06F 2119/02

(57) ABSTRACT

A method for verifying an electronic circuit design includes detecting a first issue in a register transfer level description of the electronic circuit design and receiving a selection to waive the first issue. The method also includes capturing the selection to waive the first issue in a memory, detecting, by a processing device, a second issue while generating a netlist or gate level description of the electronic circuit design, and based on determining that the selection to waive the first issue indicated in the memory applies to the second issue, suppressing or ignoring the second issue.

### RELATED APPLICATION

This application claims priority to and the benefit of U.S. Provisional Patent Application Ser. No. 63/396,113, entitled “Process to Relay Knowledge and Guide Synthesis alongside Early Detection of Logic Optimizations,” filed Aug. 8, 2022, which is incorporated herein by reference in its entirety.

### TECHNICAL FIELD

The present disclosure relates to electronic circuit design.

### BACKGROUND

Electronic circuit designs may be tested and verified at multiple stages of the design process. For example, static verification tools may be used to check for errors and issues in a register transfer level (RTL) description of a circuit design, and implementation tools may be used to generate netlists and gate level descriptions of the circuit design based on the RTL description and to check for errors and issues while generating the netlists and gate level descriptions.

### SUMMARY

Systems and methods for verifying electronic circuit designs are described. According to an embodiment, a method for verifying an electronic circuit design includes detecting a first issue in a register transfer level description of the electronic circuit design and receiving a selection to waive the first issue. The method also includes capturing the selection to waive the first issue in a memory, detecting, by a processing device, a second issue while generating a netlist or gate level description of the electronic circuit design, and based on determining that the selection to waive the first issue indicated in the memory applies to the second issue, suppressing or ignoring the second issue.

The method may include generating a summary report after suppressing or ignoring the second issue.

The method may include determining a register optimization prior to generating the netlist or gate level description and adding, to the memory, an indication of the register optimization. The indication of the register optimization may include an error message and a label indicating that the error message is for a determined optimization. The method may include, based on determining that the register optimization is indicated in the memory, noting the register optimization in an output. Adding the indication of the register optimization to the memory may include converting a message indicating the register optimization to an extensible markup language (XML) message, mapping the XML, message to an error message, and adding a label to the error message to produce the indication of the register optimization. The register optimization may include removal of a register.

According to another embodiment, a system for verifying an electronic circuit design includes a memory and a processor communicatively coupled to the memory. The processor detects a first issue in a register transfer level description of the electronic circuit design and receives a selection to waive the first issue. The processor also captures the selection to waive the first issue in a memory, detects a second issue while generating a netlist or gate level description of the electronic circuit design, and based on determining that the selection to waive the first issue indicated in the memory applies to the second issue, suppresses or ignores the second issue.

The processor may generate a summary report after suppressing or ignoring the second issue.

The processor may determine a register optimization prior to generating the netlist or gate level description and add, to the memory, an indication of the register optimization. The indication of the register optimization may include an error message and a label indicating that the error message is for a determined optimization. The processor may, based on determining that the register optimization is indicated in the memory, note the register optimization in an output. Adding the indication of the register optimization to the memory may include converting a message indicating the register optimization to an extensible markup language (XML) message, mapping the XML, message to an error message, and adding a label to the error message to produce the indication of the register optimization. The register optimization may include removal of a register.

According to another embodiment, a non-transitory computer readable medium stores instructions that, when executed by a processor, cause the processor to perform an operation for verifying an electronic circuit design. The operation includes detecting, by an implementation tool, a first issue while generating a netlist or a gate level description of an electronic circuit design and receiving, by the implementation tool, an indication of a selection to waive a second issue detected by a static verification tool in a register transfer level description of the electronic circuit design. The operation also includes, based on determining that the selection to waive the second issue applies to the first issue, suppressing or ignoring the first issue while generating a netlist or a gate level description of the electronic circuit design.

The operation may include generating a summary report after suppressing or ignoring the first issue.

The operation may include determining a register optimization prior to generating the netlist or gate level description and adding, to a memory, an indication of the register optimization. The indication of the register optimization may include an error message and a label indicating that the error message is for a determined optimization. The operation may include, based on determining that the register optimization is indicated in the memory, noting the register optimization in an output. Adding the indication of the register optimization to the memory may include converting a message indicating the register optimization to an extensible markup language (XML) message, mapping the XML, message to an error message, and adding a label to the error message to produce the indication of the register optimization.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example circuit design with registers.

FIG. 2 illustrates a portion of an example waiver data file.

FIG. 3 is a flowchart of an example method for verifying a circuit design.

FIG. 4 is a flowchart of an example method for verifying a circuit design.

FIG. 5 is a flowchart of an example method for verifying a circuit design.

FIG. 6 depicts a flowchart of various processes used during the design and manufacture of an integrated circuit in accordance with some embodiments of the present disclosure.

FIG. 7 depicts a diagram of an example computer system in which embodiments of the present disclosure may operate.

### DETAILED DESCRIPTION

Aspects of the present disclosure relate to a process to relay knowledge and guide synthesis alongside early detection of logic optimizations, such as register optimizations. Electronic circuit designs may undergo testing and verification at multiple stages of the design process. For example, static verification tools may check for errors and issues in a register transfer level (RTL) description of a circuit design. Implementation tools may be used to generate netlists and gate level descriptions of the circuit design and to check for errors and issues while generating the netlists and gate level descriptions. These tools, however, may perform their own tests and checks without knowledge of the tests and checks that were performed previously. Additionally, the different stages of the design process may be handled by different designers or different teams. As a result, the tools may detect the same issues that were detected previously.

For example, a static verification tool may analyze an RTL description of a circuit design to detect issues in the design. A first designer may then review the detected issues and decide whether to waive some of the issues to indicate that the issue is acceptable or intended. During the synthesis stage of the design process, a second, different designer may use an implementation tool and verification checker to generate and verify a netlist or gate level description of the design (e.g., based on the RTL description of the circuit design). Because the implementation tool does not have any of the information determined by the static verification tool, the implementation tool may detect some of the same issues detected by the static verification tool, especially if those issues were waived by the first designer. The second, different designer must then review these issues again. As a result, redundant work is performed by the tools and by the designers, which slows down the testing and verification process.

The present disclosure is not limited to different designers using the different tools. The same designer could use the static verification tool and the implementation tool and encounter the same issue. For example, the same designer may use the static verification tool to detect and waive issues. After some time, that designer may use the implementation tool to detect issues, but the designer may have forgotten every issue that the designer previously waived. As a result, the designer must review the some of the same issues again, which slows down the testing and verification process.

The present disclosure describes a process in which implementation and verification tools may share results from static verification tools to avoid redundancies. Generally, detected issues are captured and communicated (e.g., in a file, a stream, or other data format) among the tools as to whether those issues should be waived or not. The captured information may then be consumed by subsequent tools to determine issues that have already been detected and waived. The subsequent tools may then suppress or ignore these issues when detected so that designers do not review those issues again. In this manner, the speed of the testing and verification process is improved, in certain embodiments.

Additionally, in some embodiments, a first static verification tool may predict some of the register or logic optimizations that an implementation tool may detect. For example, the first static verification tool may analyze the RTL description of a circuit design and generate a setup for another tool, such as a RTL exploration tool (which performs quick implementation), to predict congestion metrics for the circuit design. To determine these congestion metrics, the RTL exploration tool may detect some of the register and logic optimizations that a subsequent implementation tool would determine. The RTL exploration tool may capture these register and logic optimizations in any suitable string stream, interprocess communication, or file using any suitable format (e.g., in an extensible markup language (XML) file). The stream, interprocess communication, or file may be stored (e.g., in a memory). The first static verification tool maps the optimizations to certain error or issue descriptors and then appends a label to indicate that these descriptors identify a predicted optimization. The first static verification tool may then store these error or issue descriptors and their labels in the same file or stream as the other errors or issues detected by the first static verification tool. A subsequent implementation tool may then use this captured information to suppress or ignore the same optimizations from being detected or presented. In this manner, the speed of the testing and verification process is improved, in certain embodiments.

As used herein, the terms “optimization” and “optimize” and other similar terms refer to at least an incremental improvement over a prior state. The improvement may or may not achieve the best or penultimate state.

Advantages of the present disclosure include, but are not limited to, reducing the amount of time it takes to design an electronic circuit. For example, by passing, to an implementation tool, issues detected by a static verification tool and subsequently waived, the implementation tool may automatically waive those issues or not check for those issues, so that a designer does not spend time reviewing those previously waived issues. As a result, a reduction in the amount of time it takes to complete a step of the circuit design process is realized. As another example, by passing, to the implementation tool, register optimizations that were previously detected, the implementation tool may then suppress or ignore these same optimizations so that a designer does not spend time reviewing them. As a result, another reduction in the amount of time it takes to complete a step of the circuit design process is realized. In some embodiments, the implementation tool may use fewer computing resources relative to existing systems that do not pass waived issues or detected optimizations to implementation tools, because the implementation tool may not expend computing resources checking for previously waived issues or previously detected optimizations.

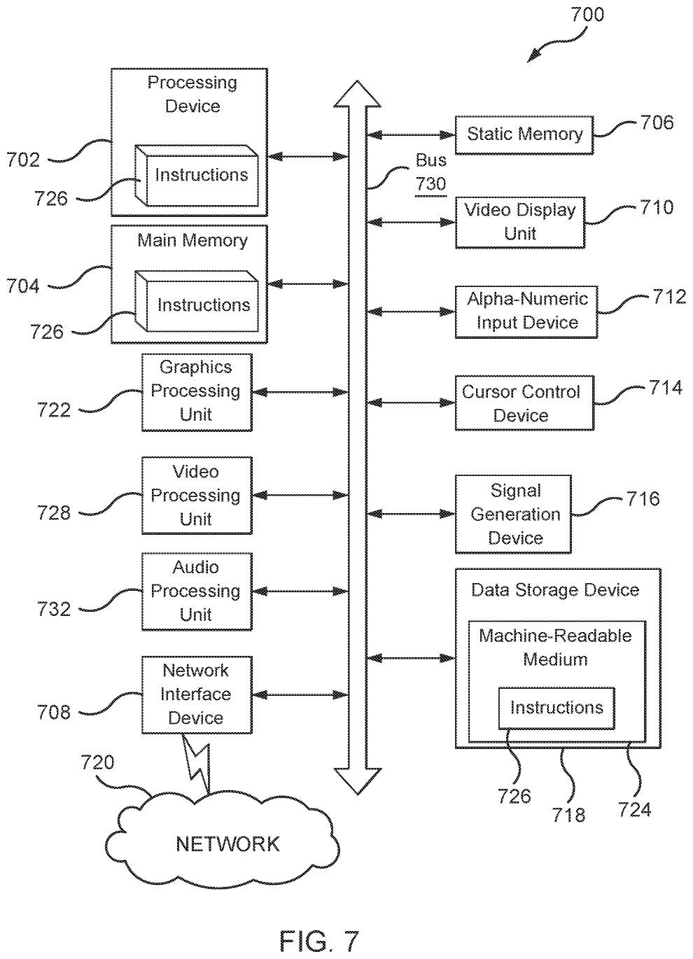

Static verification tools may provide design reuse compliance checks and comprehensive RTL analysis to enforce a consistent design style through the design phase. Often, among the warning or error messages that these tools produce, some are true design bugs that need to be fixed, while others are non-issues for the specific design. As a result, some error messages are waived by the designers during the process. Some waivers are consumed by various systems on a chip (SoCs) which are taped out and are termed as global waivers, while the others (local waivers) can be limited to a particular intellectual property (IP) or SoC version. Conventionally, the methodology being followed across the industry has no standard way of specifying waivers; hence downstream tools cannot consume the same. The present disclosure introduces a method and system (e.g., a computer system, such as the computer system 700 of FIG. 7) to have a uniform waiver mechanism, which is consumable across the toolchain (e.g., implementation tools or equivalence checkers). This will lead to substantial time savings for users so they will not have to review the same messages downstream, in certain embodiments.

Another important aspect is that synthesis tools can be aggressive in optimizations and when registers are optimized without much organized information and categorization, it may take weeks of manual efforts from multiple engineers to figure out the reasoning across various IPs. Due to the large dataset, analysis can be error prone at the synthesis stage and can impact project schedules in the highly competitive market. In addition to catching RTL design bugs, static verification tools also help in identifying potential synthesis optimization (sometimes unwanted and unknown) early. Design constructs such as constant registers, redundant registers, and equivalent registers are often optimized away during synthesis. The present disclosure contemplates alerting users of potential synthesis outcome, so users can take appropriate actions earlier in the process and hence reduce the time it takes to reach synthesis closure during implementation. Such information may be provided with precise root cause analysis. Then, the detected issue or violation can be either fixed or waived and with the help of unified waiver methodology, users will not see the same message again at implementation stage, in certain embodiments.

Every tool has its own set of checks and tool-specific reporting. Conventionally, there is no synergy in the reporting or suppression methodologies provided by the different tools. In addition, there is no handshake mechanism between the tools for exchange of relevant information. Below are some example that illustrate these challenges.

Example 1: In the below RTL, both static verification tools and synthesis tools report a warning for missing case items when “unique” is specified, which may result in redundant work being performed.

```
always @* begin
  unique casex ( c )
    3′b111: y = 5;
    3′b11x: y = 4;
    3′b1xx: y = 3;
    3′b000: y = 2;
  endcase
end
```

### Synthesizer Output:

Case statement marked unique does not cover all possible conditions

### Static Verification Tool Output:

Treating unique/priority case as full case. Case statement marked unique/priority does not cover all possible conditions

Example 2: In the below RTL, both static verification tools and synthesis tools report a warning for signed to unsigned conversion and another warning related to feedthrough paths, which may result in redundant work being performed.

input signed my_reg;
output reg my_reg_unsigned;
always @* begin
my_reg_unsigned = my_reg;
end

### Synthesizer Output:

RHS is signed and will be treated as unsigned
Input is directly connected to output

### Static Verification Tool Output:

Signed to unsigned conversion for the RHS
Feedthrough path detected from input to output

Example 3: In the below RTL, both static verification tools and synthesis tools report a warning for hanging sequential cells.

```
subtop R0(.d(d), .rst(rst), .clk(clk));
module subtop(input d,rst,clk, output q);
  reg q;
  always @(posedge clk)
    if (!rst) q <= 0;
    else q <= d;
endmodule
```

### Synthesizer Output:

Sequential cell is not driving any load

### Static Verification Tool Output:

Output of the flop is unloaded

There are numerous more examples that result in duplicities or redundancies. Although a user may mark the violations as “acknowledged” or “waived,” because there is no handshake mechanism between conventional tools, a subsequent implementation tool will continue to report these similar messages again.

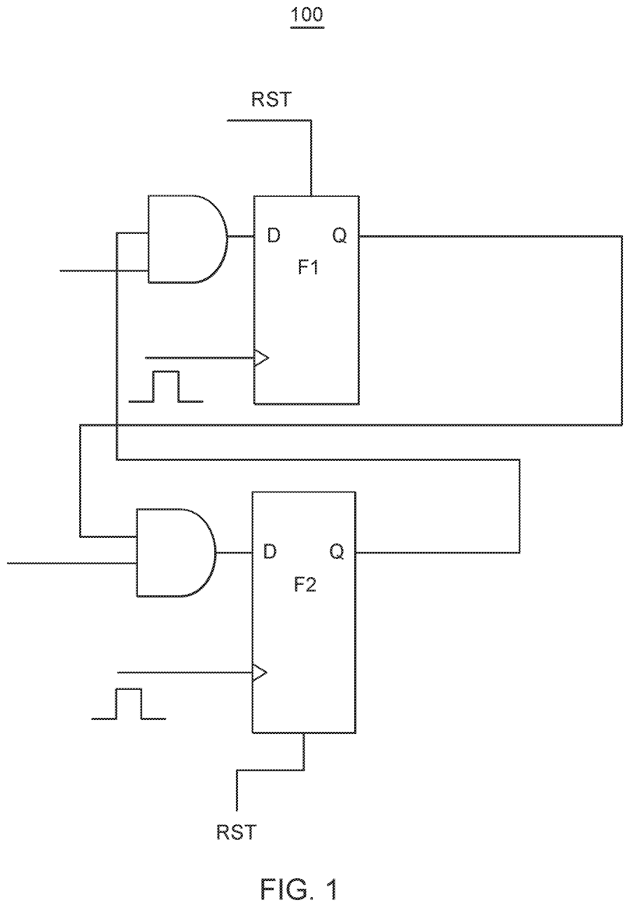

Another challenge is described using FIG. 1. Synthesis tools may remove registers using redundant register optimization techniques. In the example circuit 100 of FIG. 1, when the reset signal (RST) de-asserts, the registers F1 and F2 are stuck in their initial states, which may be an error or issue in the design. In complex scenarios related to sequential register optimization, users may have to spend multiple weeks making sure optimization is correct. If the user accidentally misses an issue, it will put an additional burden on equivalence checkers.

### Synthesis Optimization Message:

The register “F1_reg” is optimized
The register “F2_reg” is optimized

If users had the option to know about these issues at the RTL stage in an organized manner along with its potential root cause for optimization, it can significantly benefit the design process by removing certain issues from being detected and handled during the synthesis stage. The downstream implementation tools could consume the static verification tool violation status to reduce the verification effort tremendously, in certain embodiments.

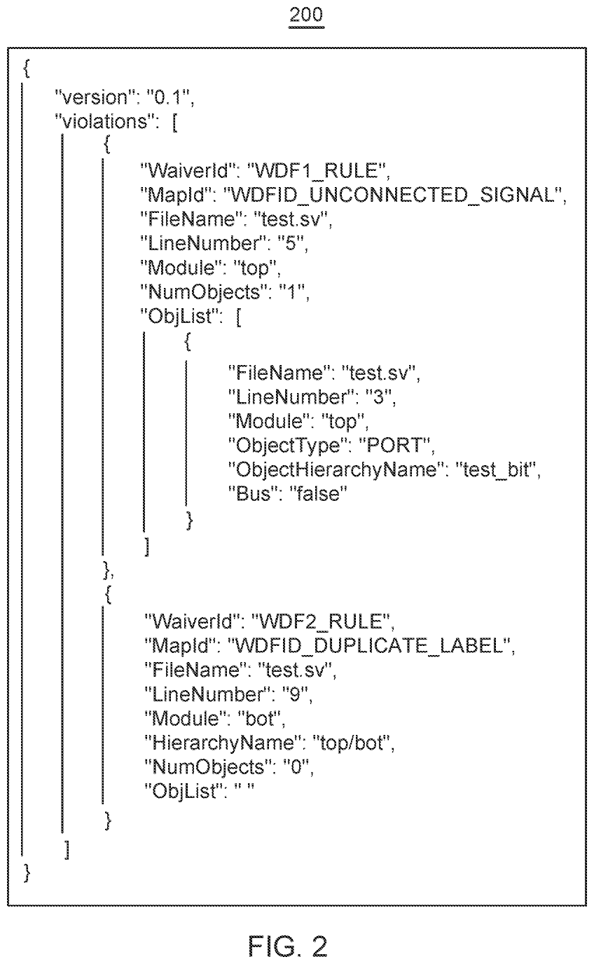

Synthesis tools may suppress the violations which have already been reviewed and waived using a static verification tool. Static verification tools may capture or store the information about detected issues and waivers in a pre-defined format. For example, the static verification tool may store this information in a file, which may be referred to herein as a Waiver Data File (WDF). The WDF would encapsulate the waived messages and object data corresponding to each of the waived messages. FIG. 2 shows a portion of an example WDF 200. Some fields in the WDF are explained below in Table 1.

TABLE 1

| | |
|---|---|
| version | Header for backward compatibility |
| Mapld | Downstream tools can have mappings |
| | based upon WDF ID |
| NumObjects | Number of objects in the violations |
| ObjLists | List of the objects; Every object will |
| | have its hierarchy name, type and bus |
| | style |

Various tools in the toolchain (synthesizer and equivalence checkers) would consume the WDF 200 and execute the appropriate action specific to the tool. Finally, a reporting module of these tools will generate a report of suppressed messages (e.g., in text or html format), which can be referred to by the end user.

In the example of FIG. 2, the WDF 200 identifies two types of detected errors or issues. The first detected error or issue is an unconnected signal (MapId: WDFID_UNCONNECTED_SIGNAl) found at line five (LineNumber: 5) of the file (FileName: test.sv). Additionally, the WDF 200 notes that this error or issue is related to another object in the circuit design. Specifically, that object is a port (ObjectType: PORT) found at line three (LineNumber: 3) of the file (FileName: test.sv). When the WDF 200 is subsequently processed (e.g., by an implementation tool), the WDF 200 will indicate that the unconnected signal at that port is a known and waived issue. As a result, the subsequent tool may ignore this issue when generating a summary report.

The second error or issue noted in the WDF 200 is a duplicate label (MapID: WDFID_DUPLICATE LABEL). This error or issue was found at line nine (LineNumber: 9) of the file (FileName: test.sv). No objects in the circuit design is related to this error. When the WDF 200 is subsequently processed (e.g., by an implementation tool), the WDF 200 will indicate that the duplicate label is a known and waived issue. As a result, the subsequent tool may ignore this issue when generating a summary report.

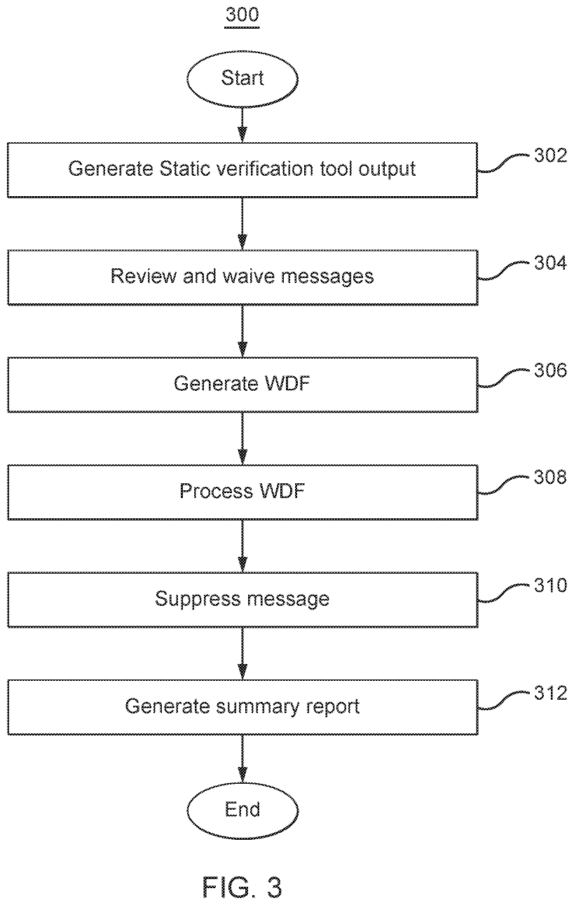

FIG. 3 is a flowchart of an example method 300. In certain embodiments, one or more computer systems (e.g., the example computer system 700 shown in FIG. 7) implement various tools that perform the steps of the method 300. By performing the method 300, the one or more computer systems reduce the amount of time to verify a circuit design.

At 302, the one or more computer systems implement a static verification tool that analyzes a circuit design and produces an output. The static verification tool may check for errors and issues in a RTL description of the circuit design. The output of the static verification tool may include warning or error messages that indicate detected issues in the circuit design. At 304, the one or more computer systems review and waive one or more of the messages from the output of the static verification tool. In some embodiments, the computer system presents the messages to a user of the static verification tool, and the user uses the static verification tool to select the messages to waive.

At 306, the one or more computer systems generate a WDF. The WDF may indicate the waived messages selected at 304 and the object data for each of the waived messages. The one or more computer systems may use the WDF during subsequent steps to determine the messages that were previously waived.

At 308, the one or more computer systems process the WDF. For example, the one or more computer systems may implement an implementation tool that generates a netlist or gate level description based on the RTL description of the circuit design and checks for errors and issues while generating the netlist or the gate level description. While running the implementation tool, the one or more computer systems may process or analyze the WDF to determine the warning messages from the output of the static verification tool that were previously waived. The implementation tool may detect errors or issues while generating the netlist or gate level description and produce an output. This output may include messages that identify the detected errors or issues. The one or more computer systems may compare the messages from the output of the implementation tool to the waived messages in the WDF. The one or more computer systems may then suppress the messages from the output of the implementation tool that match a waived message in the WDF at 310. In some embodiments, the message from the output of the implementation need not be an exact match with the waived message for the one or more computer systems to suppress the message. Rather, it may be sufficient for the message to identify the same error or issue with the same circuit object as the waived message. Stated differently, it may be sufficient for the one or more computer systems to determine that the waived message in the WDF applies to the issue detected while generating the netlist or gate level description.

The one or more computer systems then generate a summary report based on the remaining output of the implementation tool. The summary report may not include or present the suppressed messages, but the summary report may include or present the unsuppressed messages of the implementation tool. In some embodiments, the summary report may include the suppressed messages (e.g., in a separate section of the summary report). In this manner, the summary report identifies for the user of the implementation tool the messages pertaining to errors or issues that were not previously detected and waived. As a result, the one or more computer systems reduce the number of errors or issues that the user will need to investigate, which reduces the amount of time it takes to verify the circuit design.

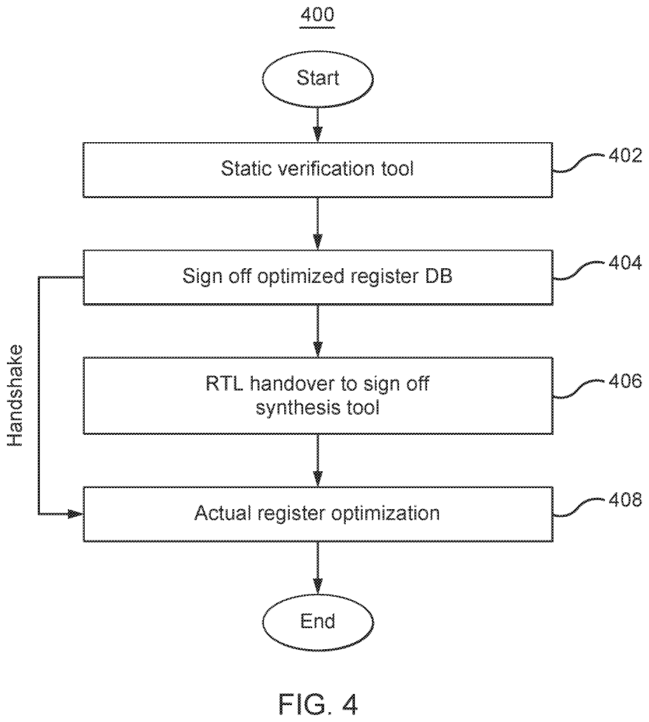

FIG. 4 is a flowchart of an example method 400 for register optimization. In certain embodiments, one or more computer systems (e.g., the example computer system 700 shown in FIG. 7) may perform the method 400. As seen in FIG. 4, there is a handshake mechanism between the static verification database and the sign-off synthesis tool. Synthesis optimizations can be caught early in the static verification phase and can help the design team to take informed actions in the RTL, even before running synthesis. A static verification user may sign-off the report containing registers, which may be optimized eventually during actual synthesis. Then, the RTL is handed over to the synthesis tool, and at that time, the static verification tool's output about optimized registers can be read in.

At 402, the static verification tool is used to check for errors or issues in an RTL description of a circuit design. The circuit design may include registers. The static verification tool may identify synthesis optimizations and present these optimizations in the output or report of the static verification tool. At 404, a user of the static verification tool signs off on the report from the static verification tool. As a result, the user may sign off or approve of that the synthesis optimizations detected by the static verification tool should be made during synthesis.

At 406, the RTL is handed over to the synthesis tool. The synthesis tool may begin its analysis and consider the register optimizations detected by the static verification tool at 402. For example, a handshake procedure may be used in which the signed off report from the static verification tool is analyzed or consumed by the synthesis tool. The synthesis tool may then make the register optimizations at 408. As a result, some of the work typically done by the synthesis tool is shifted to an earlier portion of the verification process and the overall verification may be reduced, in certain embodiments.

Generally, the static verification tool being aware of synthesis messages and generating a summary of incremental optimizations may greatly increase productivity. Users will end up reviewing a much smaller list of deleted registers, in certain embodiments.

Table 2 below shows the data where a static verification tool can warn upfront about the potential issues in the synthesis/equivalence checker with the proposed solution. Table 2 also shows the number of messages that a synthesis tool suppresses based on the errors or issues detected by the static verification tool. As seen in Table 2, the synthesis tool can suppress a large percentage of messages using the messages from the static verification tool, and hence end users may need to do incremental analysis only.

TABLE 2

| | | Suppress Msg | |
|---|---|---|---|
| | | commands in | |
| | | synthesis tool | |
| | | after consuming | |
| | Static | the information | |
| | verification tool | from the | % |
| Design | (total viol count) | static checker | Saving |
| D1 | 2452 | 2032 | ~83% |
| D2 | 256 | 113 | ~44% |
| D3 | 1535 | 504 | ~33% |

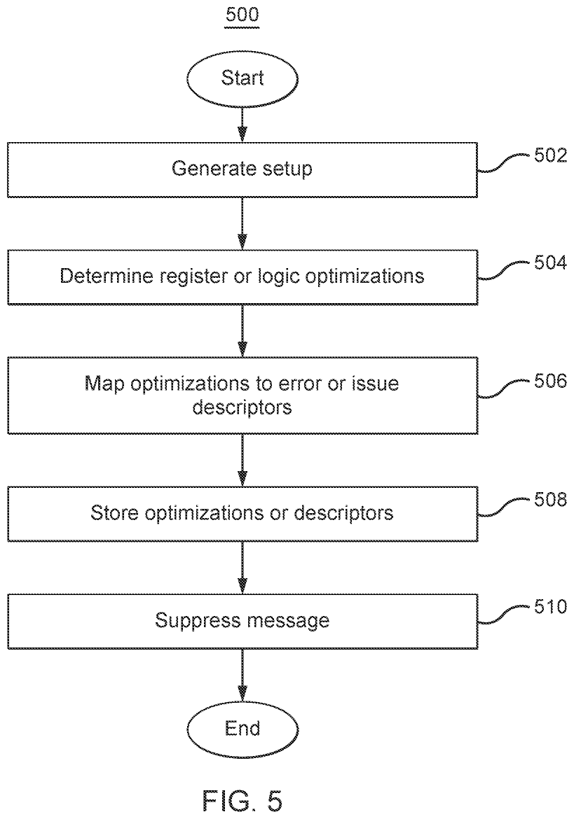

In some embodiments, FIG. 5 is a flowchart of an example method 500. In certain embodiments, one or more computer systems (e.g., the example computer system 700 shown in FIG. 7) perform the method 500. By performing the method 500, a static verification tool may generate a setup for another tool (e.g., a RTL exploration tool) that detects some of the optimizations that a subsequent implementation tool may determine. These optimizations may be captured for the static verification tool (e.g., in an XML file) and then stored by the static verification tool (e.g., in a WDF). The implementation tool may then use the information stored by the static verification tool to suppress or ignore the same optimizations from being detected or presented. In this manner, the speed of the testing and verification process is improved, in certain embodiments.

At 502, the static verification tool generates a setup for another tool, such as an RTL exploration tool. In some embodiments, the RTL exploration tool may perform quick implementation checks to determine metrics for a circuit design (e.g., congestion metrics). To determine some of these metrics, the RTL exploration tool may detect some of the register or logic optimizations that a subsequent implementation tool would determine. At 504, the RTL exploration tool determines the register or logic optimizations for the circuit design using the setup from the static verification tool. The RTL exploration tool may determine these optimizations as part of its process for determining the metrics for the circuit design. The RTL exploration tool may capture and store these detected optimizations in any suitable manner (e.g., a string stream, an interprocess communication, a file) using any suitable format in any suitable location (e.g., in memory). For example, the RTL exploration tool may convert messages indicating the register or logic optimizations to an XML file. The register or logic optimization may be any suitable optimization. For example, the optimization may include the removal or a register or certain logic elements from the circuit design.

At 506, the static verification tool maps the optimizations noted in the XML file to error or issue descriptors or messages that would typically be used by the static verification tool. For example, the static verification tool may map the optimizations noted in the XML to descriptors of errors or issues for which the static verification tool checks. In some embodiments, the static verification tool also appends a label to indicate that these descriptors identify a predicted optimization. At 508, the static verification tool stores the optimizations and/or the mapped descriptors and labels. For example, the static verification tool may store this information in a WDF.

At 510, the subsequent implementation tool suppresses messages by analyzing the WDF from the static verification tool. For example, the implementation tool may check for errors or issues while generating a netlist or gate level description of the circuit design. The implementation tool may compare detected errors or issues with the errors or issues noted in the WDF. If a detected error or issue is already noted in the WDF, the implementation tool may suppress messages relating to that error or issue so that the implementation tool user does not need to analyze those messages.

Catching potential issues early in the design cycle may allow the designer to avoid redundant iterative runs. Static verification tools are typically run before synthesis tools. If a static verification tool can capture these issues related to logic optimizations early, it will tremendously save time and resources by avoiding the costly iterations by the downstream tools. An efficient handshake mechanism for information transfer between the different toolchains may significantly improve efficiency and productivity.

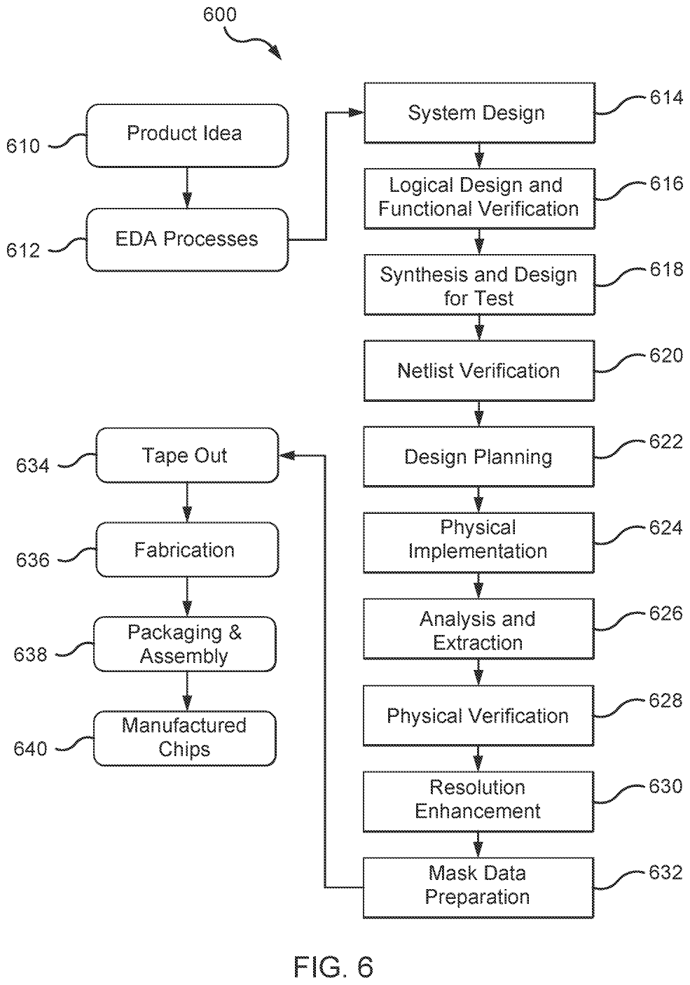

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for verifying an electronic circuit design, the method comprising:
detecting a first issue in a register transfer level description of the electronic circuit design;
receiving a selection to waive the first issue;
capturing the selection to waive the first issue in a memory;
detecting, by a processing device, a second issue while generating a netlist or gate level description of the electronic circuit design; and
based on determining that the selection to waive the first issue indicated in the memory applies to the second issue, suppressing or ignoring the second issue.

2. The method of claim 1, further comprising generating a summary report after suppressing or ignoring the second issue.

3. The method of claim 1, further comprising:
determining a register optimization prior to generating the netlist or gate level description; and
adding, to the memory, an indication of the register optimization.

4. The method of claim 3, wherein the indication of the register optimization comprises an error message and a label indicating that the error message is for a determined optimization.

5. The method of claim 3, further comprising, based on determining that the register optimization is indicated in the memory, noting the register optimization in an output.

6. The method of claim 3, wherein adding the indication of the register optimization to the memory comprises:
converting a message indicating the register optimization to an extensible markup language (XML) message;
mapping the XML message to an error message; and
adding a label to the error message to produce the indication of the register optimization.

7. The method of claim 3, wherein the register optimization comprises removal of a register.

8. A system for verifying an electronic circuit design, the system comprising:
a memory; and
a processor communicatively coupled to the memory, the processor configured to:
detect a first issue in a register transfer level description of the electronic circuit design;
receive a selection to waive the first issue;
capture the selection to waive the first issue in a memory;
detect a second issue while generating a netlist or gate level description of the electronic circuit design; and
based on determining that the selection to waive the first issue indicated in the memory applies to the second issue, suppress or ignore the second issue.

9. The system of claim 8, wherein the processor is further configured to generate a summary report after suppressing or ignoring the second issue.

10. The system of claim 8, wherein the processor is further configured to:
determine a register optimization prior to generating the netlist or gate level description; and
add, to the memory, an indication of the register optimization.

11. The system of claim 10, wherein the indication of the register optimization comprises an error message and a label indicating that the error message is for a determined optimization.

12. The system of claim 10, wherein the processor is further configured to, based on determining that the register optimization is indicated in the memory, note the register optimization in an output.

13. The system of claim 10, wherein adding the indication of the register optimization to the memory comprises:
converting a message indicating the register optimization to an extensible markup language (XML) message;
mapping the XML message to an error message; and
adding a label to the error message to produce the indication of the register optimization.

14. The system of claim 10, wherein the register optimization comprises removal of a register.

15. A non-transitory computer readable medium storing instructions that, when executed by a processor, cause the processor to perform an operation for verifying an electronic circuit design, the operation comprising:
detecting, by an implementation tool, a first issue while generating a netlist or a gate level description of an electronic circuit design;
receiving, by the implementation tool, an indication of a selection to waive a second issue detected by a static verification tool in a register transfer level description of the electronic circuit design; and
based on determining that the selection to waive the second issue applies to the first issue, suppressing or ignoring the first issue while generating a netlist or a gate level description of the electronic circuit design.

16. The medium of claim 15, wherein the operation further comprises generating a summary report after suppressing or ignoring the first issue.

17. The medium of claim 15, wherein the operation further comprises:
determining a register optimization prior to generating the netlist or gate level description; and
adding, to a memory, an indication of the register optimization.

18. The medium of claim 17, wherein the indication of the register optimization comprises an error message and a label indicating that the error message is for a determined optimization.

19. The medium of claim 17, wherein the operation further comprises, based on determining that the register optimization is indicated in the memory, noting the register optimization in an output.

20. The medium of claim 17, wherein adding the indication of the register optimization to the memory comprises:
converting a message indicating the register optimization to an extensible markup language (XML) message;
mapping the XML message to an error message; and
adding a label to the error message to produce the indication of the register optimization.
